(19) United States
(12) Patent Application Publication
(10) Pub. No.: US 2023/0055428 A1
(43) Pub. Date: Feb. 23, 2023

(54) METHOD AND SYSTEM FOR OPTIMIZING A MANUFACTURING PROCESS

(71) Applicant: SANDVIK MACHINING SOLUTIONS AB, Sandviken (SE)

(72) Inventors: Hugo NORDELL, Sandviken (SE); Vahid KALHORI, Sandviken (SE)

(21) Appl. No.: 17/785,797

(22) PCT Filed: Dec. 15, 2020
(86) PCT No.: PCT/EP2020/086151

§ 371 Date: Jun. 15, 2022

(30) Foreign Application Priority Data
Dec. 20, 2019 (SE) 1900215-3

(51) Int. Cl. G05B 19/4097

(52) U.S. Cl. CPC G05B 19/4097; G05B 2219/32015; G05B 2219/35134

(57) ABSTRACT

A method for optimizing manufacturing data in a subtractive manufacturing system includes obtaining a model of and tolerance requirements for an object to be manufactured and performing measurements on the manufacturing system in a static condition. The method further includes simulating a manufacturing process in the manufacturing system using the obtained static information to obtain runtime information, determining which manufacturing data is responsible for producing each feature of the manufactured object, simulating manufacturing of the object, and comparing the simulated finished product of the object with the three-dimensional model of the object, detecting a deviation between the simulated finished product and the obtained tolerance requirements included in the model, and based on the detected deviation and the determination of which manufacturing data is responsible for producing each feature, optimizing the manufacturing data such that an object manufactured based on the optimized manufacturing data complies with the obtained tolerance requirements.

### TECHNICAL FIELD

The present disclosure relates generally to methods, systems and computer programs for optimizing a manufacturing process, more specifically for evaluating whether certain manufacturing data results in a manufactured object that is within predetermined tolerance levels and optimizing the manufacturing data if needed.

### BACKGROUND

Today, three dimensional, 3D, models, such as computer-aided design (CAD) models, are often employed to define objects to be manufactured by subtractive manufacturing. The manufacturing is typically performed via machining operations performed by one or more machine tools. A cutting tool mounted in the machine tool is moved by the machine tool relative to a work piece, so that the cutting tool cuts away material from the work piece, to e.g. form one or more geometric features of the object to be manufactured.

Dedicated software, such as Computer-aided manufacturing (CAM) software, is used to analyze the CAD model and generate instructions, such as g-code, for manufacturing the object. The instructions comprises a representation of a cutting tool movement path or tool path and/or activation/deactivation of machine tools functions. In other words, CAM software is used for determining machining strategies that indicates how to manufacture the object, defined by the 3d model.

A problem in subtractive manufacturing is that the actual tool path of a cutting tool, moved by the machine tool, will deviate from the reference tool path indicated by the generated instructions. Such deviations arise because of a vast array of different reasons, for example not accounting for that tools get hotter the longer they run, that tools get worn out from use.

In conventional solutions, the instructions are adapted by a skilled technician with deep knowledge of the particular machine tool. In one example, a machine operator may adapt or modify the machine code/g-code based on own knowledge and experience of the machine tool.

A drawback of such conventional solutions is that machine operators still need to rely on experience as well as multiple trial and error runs to obtain an acceptable manufactured object complying with the tolerance requirements.

It would be desirable to provide new ways to address one or more of the abovementioned issues.

Consequently, there exists a need for improvement when it comes to subtractive manufacturing systems and methods for evaluating and optimizing manufacturing data.

### SUMMARY

It is an object of the invention to address at least some of the problems and issues outlined above. An object of embodiments of the invention is to provide methods, systems, computing devices and computer programs which increase the quality of produced objects in a manufacturing system. It is further an object to decrease the number of objects that have to be scrapped due to not meeting tolerance requirements. It may be possible to achieve these objects, and others, by using methods, systems, computing devices and computer programs as defined in the attached claims.

According to one aspect a method for optimizing manufacturing data in a subtractive manufacturing system is provided. The manufacturing system is adapted to manufacture an object based on a three-dimensional model, and the object comprises a plurality of features. The method comprises obtaining a model of and tolerance requirements for the object to be manufactured, and performing measurements on the manufacturing system in a static condition, in order to obtain static system information, wherein the static system information describes the positions and dimensions of components in the manufacturing system. The method further comprises simulating a manufacturing process in the subtractive manufacturing system using the obtained static information, in order to obtain runtime information, wherein the runtime information describes the behavior of the manufacturing system during a manufacturing process. The method further comprises determining which manufacturing data is responsible for producing each feature of the object in a manufactured object, and then simulating manufacturing of the object, using the obtained static information and the obtained runtime information. The method further comprises comparing the simulated finished product of the object with the three-dimensional model of the object and detecting a deviation between the simulated finished product and the obtained tolerance requirements comprised in the model of the object. The method further comprises, based on the detected deviation and the determination of which manufacturing data is responsible for producing each feature, optimizing the manufacturing data such that an object manufactured based on the optimized manufacturing data complies with the obtained tolerance requirements.

According to another aspect, a computing device for optimizing manufacturing data in a subtractive manufacturing system is provided. the manufacturing system is adapted to manufacture an object based on a three-dimensional model, and the object comprises a plurality of features. The computing device comprises processing circuitry and a memory, wherein the memory contains instructions executable by the processing circuitry, whereby said computing device is operative for obtaining a model of and tolerance requirements for the object to be manufactured and performing measurements on the manufacturing system in a static condition, in order to obtain static system information, wherein the static system information describes the positions and dimensions of components in the manufacturing system. The computing device is further operative for simulating a manufacturing process in the subtractive manufacturing system using the obtained static information, in order to obtain runtime information, wherein the runtime information describes the behavior of the manufacturing system during a manufacturing process. The computing device is further operative for determining which manufacturing data is responsible for producing each feature of the object in a manufactured object and simulating manufacturing of the object, using the obtained static information and the obtained runtime information. The computing device is further operative for comparing the simulated finished product of the object with the three-dimensional model of the object, detecting a deviation between the simulated finished product and the obtained tolerance requirements comprised in the model of the object, and based on the detected deviation and the determination of which manufacturing data is responsible for producing each feature, optimizing the manufacturing data such that an object manufactured based on the optimized manufacturing data complies with the obtained tolerance requirements.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 shows a prior art manufacturing system.

FIG. 2 shows a manufacturing system according to an embodiment.

FIG. 3 shows a schematic view of a server.

FIG. 4 shows steps of a method according to an embodiment.

FIG. 5 shows a cutting insert and its functional measurements.

FIG. 6 shows a raw stock material and layers removed from a raw stock material during operation.

FIG. 7 shows a computing device according to an embodiment.

### DETAILED DESCRIPTION

Briefly described, the present disclosure relates to a method and corresponding system for evaluating and optimizing manufacturing data of a subtractive manufacturing system. In a first step, the manufacturing system is measured when the system is static, i.e. standing still, and information about the system is thus obtained. In a second step, operation of the system is simulated using all of the measured information from the first step as input variables, in order to obtain information about the system when it is running, such as the kinematic and the dynamic system behavior of the tools, fixturing/clamping systems and the machines, the impact of temperature increases or residual stresses of the part leading to spring-back/part distortion behavior in the system during production, and wear on the tools as they are being used. The information obtained in the first and second steps is then used in order to determine which manufacturing data is responsible for producing each feature in the finished product, such that corresponding manufacturing data can be determined for any given feature. By using the determined relationship between manufacturing and resulting features, it can then be determined whether certain cutting data and parts of the tool path will result in a finished product, or a certain feature of a finished product, that meets predetermined tolerance requirements.

An object to be manufactured in a subtractive manufacturing system comprises a plurality of features, such that the combination of all features make up the object. Requirements of an object to be manufactured may be specified in the 3D model, or it may be provided separately from the 3D model, either as data in a computer system or as written information that needs to be scanned or entered into the system. The requirement information typically comprises information regarding accepted tolerances for each feature of the object, wherein the tolerances denote how much each feature is allowed to differ from the nominal, i.e. intended, measurements and still be regarded as acceptable. Since an object comprises a plurality of different features, the tolerance requirements for all features in combination are needed in order to obtain the tolerance requirements for a completed object. However, due to the interdependency of individual features of an object, a difference in measurements of one feature may, and likely will, impact the tolerance requirements for other features of the object.

A problem in subtractive manufacturing is that the actual tool path of a cutting tool, moved by the machine tool, will deviate from a reference tool path indicated by the generated instructions. Such deviations are due to a vast number of different factors, such as for example that the positions of components in a subtractive manufacturing system differing from their intended positions, the functional measurements not being taken into account, that components in the system are effected by thermal expansion, that tools and machines characteristics and/or measurements change as a result of this. In addition to deviations in the system, there may also be a difference between the theoretical measurements of the manufacturing, and the actual measurements. For example, the actual positions of components in the system may differ from the intended position, due to various reasons such as kinematic error of fixturing, deviations with respect to , cutting tool, kinematic machine spindle offset or other machine offset; or the spring back of parts caused by residual stresses during machining or after unclamping of the part. As will be understood, there may also be a vast number of other reasons for differing positions and/or measurements of components in the manufacturing system.

A result of that the characteristics and measurements of a manufacturing system differs from the intended, and likely indicated, characteristics and measurements of the system, is that an object manufactured using the system will also differ, to at least some degree, from how it is supposed to be. As a consequence, the risk of manufactured objects not meeting the requirements increases as the differences between the theoretical behavior of the manufacturing system and the actual behavior of the manufacturing system increases. Typically, this is noticed only after the fact, i.e. after an object has been manufactured, by measuring the manufactured object and comparing it with a model of how the object is supposed to look. If a manufactured object deviates too much from its tolerance requirements, the object will be deemed to not have a high enough quality and will need to be scrapped. This is costly, so naturally the less objects that have to be scrapped the better.

By gathering as much information as possible when the system is standing still, and not only using the information comprising the theoretical measurements of the system, and following that up by simulating the operation of the system to obtain runtime information, a more precise understanding of the system can be obtained than with presently available methods. Further, by doing a determination of which manufacturing data is responsible for producing which feature, a determination if certain manufacturing data will result in a manufactured object which meets predetermined tolerance requirements can be made, which is both faster and more accurate than currently available systems, and does not require any scrapping of physical products in order to calibrate the system.

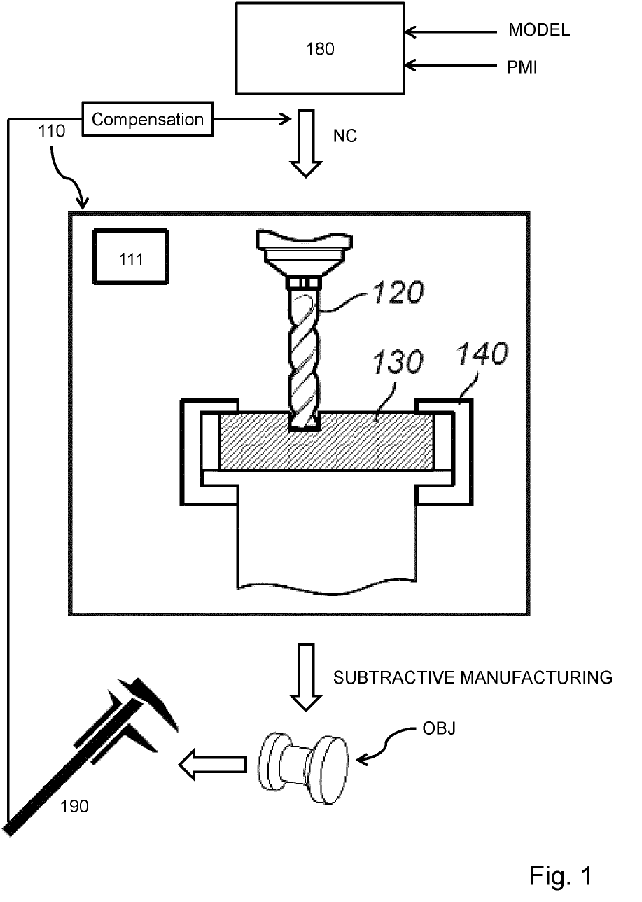

FIG. 1 shows a prior art system for performing subtractive manufacturing. The system comprises one or more machine tools 110 are arranged for performing subtractive manufacturing. The machine tool 110 may for example be adapted for metal cutting. The machine tool 110 may be adapted to perform machining operations, for example metal cutting operations, such as drilling, milling, turning, reaming, or threading. The machining operations are typically performed using cutting tools 120. A computer or computer system 180, e.g. a Computer-aided manufacturing (CAM) system, e.g. in the form of a stationary or laptop computer, a tablet computer or a smart phone, equipped with suitable software, may be configured to read or load a three-dimensional, 3D, model, MODEL, and product and manufacturing information (PMI) related to the 3D models, e.g. from a database. The 3D model may be a CAD model, for example in the form of a STEP file. The 3D model may in some embodiments include product and manufacturing information PMI. Alternatively, the PMI may be provided separate from the CAD model. However, other formats could also be employed for the 3D model. The 3D model may be retrieved from a database of stored models, or may be provided by the user.

The computer or computer system 180 may further be configured to generate instructions indicative of one or more tool paths, e.g. cutter location data/CL-data, based on the 3D model and/or the PMI.

One or more cutting tools 120 are available for use by the machine tool 110 to perform the machining operations, in which the one or more cutting tools 120 moves relative to a work piece 130 along a tool path for cutting away material from the work piece 130 to manufacture an object, or geometric features of the object, via subtractive manufacturing. In some embodiments, the CAM system comprises information regarding the material of the work piece 130.

One or more fixtures 140 may be available for holding and/or moving the work piece 130 in position during the machining or subtractive manufacturing. The machine tools 110 may further be equipped with cooling systems (not shown) for providing cooling during machining. The cooling may for example be provided via activation/deactivation of a cooling fluid, e.g. controlled by commands in the executed g-code.

Each machine tool 110 is operatively connected to a computer/controller 111 for controlling the machine tool 110, and in some embodiments each machine tool 110 comprises a corresponding controller 111. The controller 111 of the machine tool may for example control servos of the machine tool 110 for moving the cutting tool 120 relative to the work piece 130 based on the instructions and/or g-codes. In some machine tools 110, the controller 111 may cause both the cutting tool 120 and the work piece 130 to move. The machine tool 110 may for example be a computer numerically controlled (CNC) machine tool 110, and the controller 111 may be adapted to execute g-code, CNC code or machine tool code.

An object OBJ to be manufactured may be defined by the 3D model. The model may be stored in a model database, which may be a cloud storage database. Tolerance requirements for various parameters of the object such as surface quality, shape accuracy, geometric dimensions and/or surface finish may be specified via product and manufacturing information PMI.

For the machine tool 110 to be able to manufacture the object in accordance with the 3D model and the PMI, appropriate instructions, such as g-code or machine tool code, needs to be generated for the controller 111 of the machine tool 110. The instructions may be generated by software executed by the controller 111 and/or the server 310 and/or the computer or computer system 180.

The machine tool 110 then executes the instructions, g-code or machine tool code to manufacture an object OBJ, or prototype object.

Measurements are then typically performed, at least in prior art systems, on the prototype object to see if it has acceptable dimensions and tolerances, as defined by the tolerance requirements. However, the present disclosure aims to move away from the need to perform measurements after production of an object, to instead performing a more thorough analysis and simulation of the manufacturing before production is even started, with the aim to reduce or even entirely eliminate the need for measuring object after they have been produced and consequently also the need to recalibrate the system.

In prior art systems, if the dimensions and tolerances are not acceptable, the instructions are manually adjusted and another trial and error cycle is performed. Adjustment of such instructions or machine tool code or CNC code is a complicated task including generating machining strategies, involving selection of for example operation sequences (for example in which order to perform different operation steps such as facing, hole making, and threading), machine tools 110, cutting tools 120, fixtures 140, tool paths and cutting data (such as feed rate, cutting speed, and depth of cut).

Such prior art methods thus have high complexity and requires extensive time for configuring instructions manufacturing of the object by subtractive manufacturing.

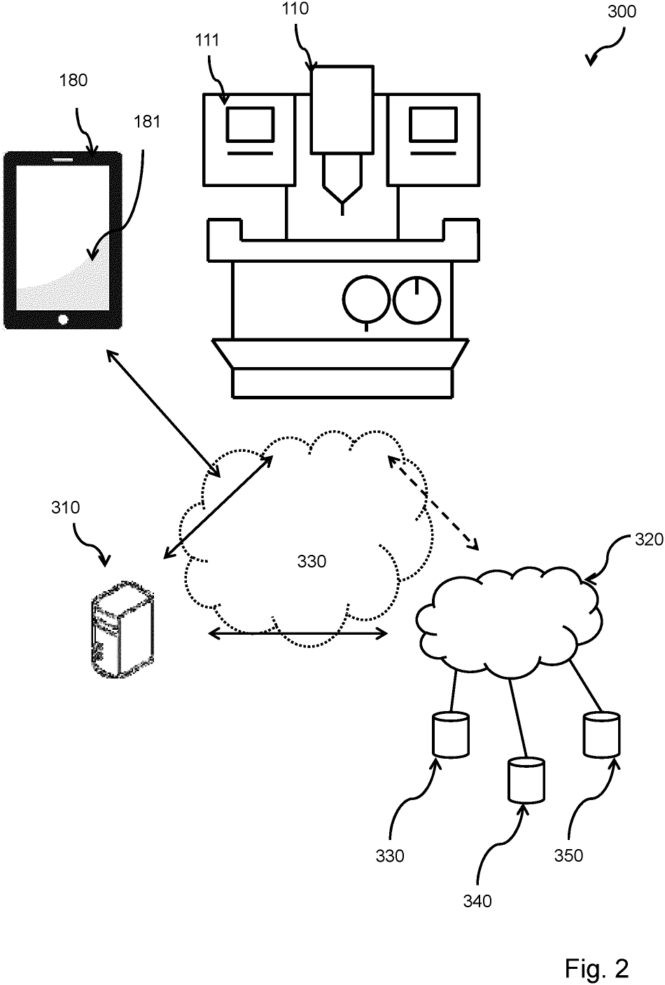

FIG. 2 shows a system 300 for machining an object via subtractive manufacturing according to one or more embodiments.

The system 300 comprises, in addition to machine tools 110 and corresponding controllers 111, a computer or computer system 180. In some embodiments, the computer system 180 may be in the form of a tablet computer equipped with suitable Computer Aided Manufacturing software. In such embodiments, the computer system 180 in the form of a tablet may be adapted to obtain a touch-based input from a user. The computer system 180 is configured to obtain, read or load a 3D model, such as a CAD model in the form of a STEP file, and/or product and manufacturing information (PMI) related to the 3D model. Additionally or alternatively, the CAD model may include product and manufacturing information PMI. Additionally or alternatively, product and manufacturing information PMI may be provided separate from the CAD model. However, it is understood that any other formats could also be employed for the 3D model. The 3D model may be retrieved via the network 330 from a database of stored models, or may be directly provided, e.g. provided based on input by a user of the computer system 180.

The computer system 180 may further be configured to, based on the 3D model and/or the PMI, generate initial instructions, i.e. a set of instructions or a program, comprising a tool path, e.g. using cutter location data/CL-data, for causing the machine tool 110 to perform machining operations to manufacture the object according to the 3D model via subtractive manufacturing. The computer system 180 is typically equipped with a user interface 181 for user interaction. The user interface 181 may for example be a human machine interface (HMI). The HMI may for example include a touch screen 181 and one or more keys or buttons.

The PMI may comprise or indicate geometric dimensioning and tolerancing, GD&T, data, wherein the GD&T data describes the tolerance requirements of the object using a specific language. The PMI may also specify the material of the work piece 130 to be employed to manufacture the object.

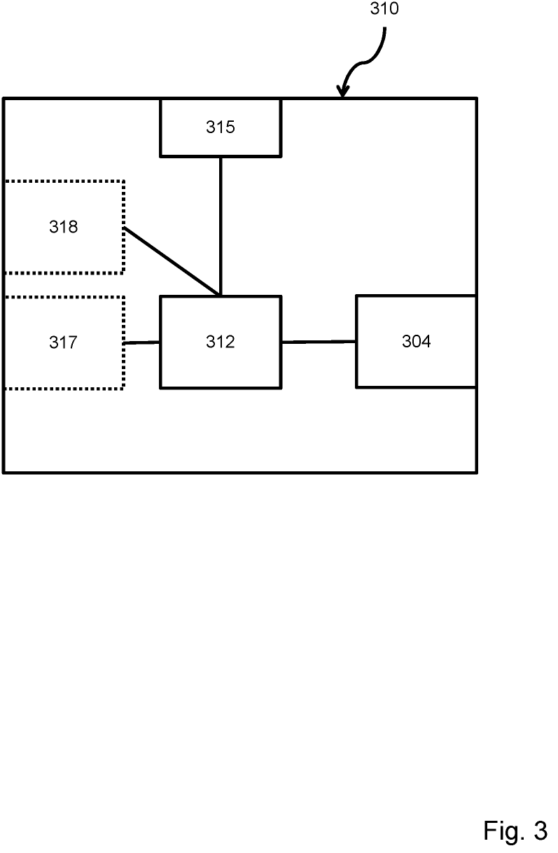

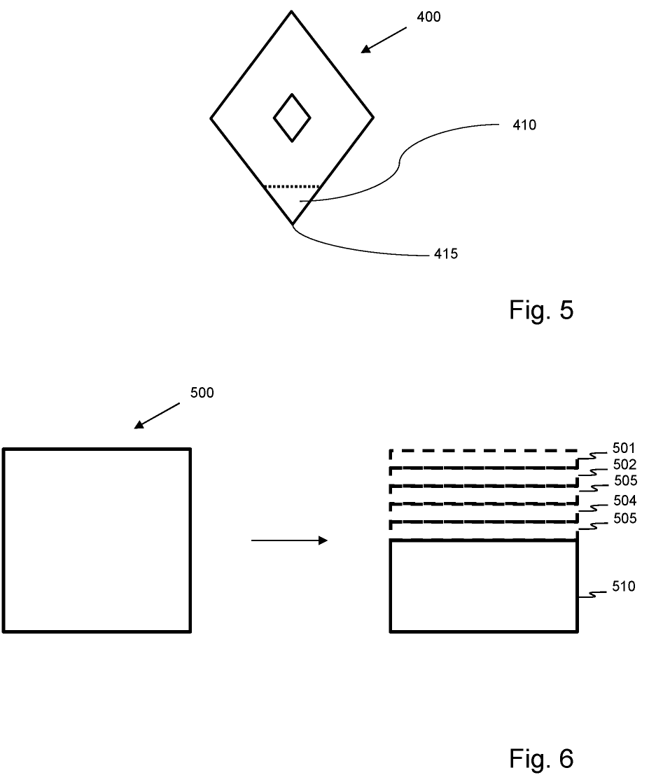

The system may further comprise a server 310, further described in relation to FIG. 3. The server 310 is typically configured to generate updated instructions, as further described in relation to the method in FIG. 5 and optionally send the updated instructions as a control signal to other entities or nodes via Wired or wireless communication. The system further comprises a controller 111 of a machine tool 110 configured to receive the updated instructions from the server 310 and to machine or manufacture an object via subtractive manufacturing based on the updated instructions.

The system further comprises a machine tool 110 controlled by the controller 111. The machine tool may be any machine tool suitable for subtractive manufacturing, e.g. a computer numerically controlled (CNC) machine tool provided with various cutting tools, as further described in relation to FIG. 1.

The system further optionally comprises a cloud storage 320 configured to store or retrieve data to/from one or more storage devices 330-350. The cloud storage 320 is further configured to receive data to be stored in control signals, e.g. received directly from a node or over a communications network 330. The cloud storage 320 is further configured to send retrieved data in control signals, e.g. received directly from a node 310, 111 or over a communications network 330. The storage devices 330-350 may comprise at least one of a hard disk drive, a hard Random Access Memory, RAM, a flash drive, a disk drive, a floppy disk drive, a magnetic tape drive, an optical disk drive, a CD or DVD drive (R or RW), or other removable or fixed media drive.

The system further optionally comprises a communications network 330, configured to exchange signals or control signals between nodes 111, 310, 320, e.g. exchange control signals indicative of processing means 170 between the server 310 and the controller 111.

Additionally or alternatively, the communications network 330 communicate using wired or wireless communication techniques that may include at least one of a Local Area Network (LAN), Metropolitan Area Network (MAN), CAN bus, Global System for Mobile Network (GSM), Enhanced Data GSM Environment (EDGE), Universal Mobile Telecommunications System, Long term evolution (LTE), 5G New Radio (NR), High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, WirelessMAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

In one embodiment, a system 300 is provided for machining an object via subtractive manufacturing, the system comprises a controller 111 and/or a computer/computer system 180 and/or a server 310, and a machine tool 110 configured to machine an object via subtractive manufacturing using instructions processed by the a controller 111 and/or a computer 180 and/or a server 310.

FIG. 3 shows a server 310 according to one or more embodiments of the present disclosure.

The server 310 may be in the form of any one of one or more interacting servers, one or more virtual servers, an on-board computer, a digital information display, a stationary computing device, a laptop computer, a tablet computer, a handheld computer, a wrist-worn computer, a smart watch, a PDA, a Smartphone, a smart TV, a telephone or a media player.

The server 310 may comprise processing circuitry 312 optionally communicatively coupled to a transceiver 304 for wired and/or wireless communication. Further, the server 310 may further comprise at least one optional antenna (not shown in figure). The antenna may be coupled to the transceiver 304 and is configured to transmit and/or emit and/or receive a wireless signals in a wireless communication system, e.g. send/receive control signals between the server 310, the controller 111 and the cloud storage. In one example, the processing circuitry 312 may be any of a selection of processor and/or a central processing unit and/or processor modules and/or multiple processors configured to cooperate with each-other.

Further, the server 310 may further comprise a memory 315. The memory 315 may contain instructions executable by the processing circuitry to perform any of the methods and/or method steps described herein.

The server 310 may further comprise a communications interface, e.g. the wireless transceiver 304 and/or a wired/wireless communications network adapter, which is configured to send and/or receive data values or parameters as a signal or control signal to or from the processing circuitry 312 to or from other external nodes, e.g. a control information server and/or other servers and/or sensors of the vehicle. In an embodiment, the communications interface communicates directly between communication network nodes or via the communications network.

In one or more embodiments the server 310 may further comprise an input device 317, configured to receive input or indications from a user and send a user-input signal indicative of the user input or indications to the processing circuitry 312.

In one or more embodiments the server 310 may further comprise a display 318 configured to receive a display signal indicative of rendered objects, such as text or graphical user input objects, from the processing circuitry 312 and to display the received signal as objects, such as text or graphical user input objects.

In one embodiment the display 318 is integrated with the user input device 317 and is configured to receive a display signal indicative of rendered objects, such as text or graphical user input objects, from the processing circuitry 312 and to display the received signal as objects, such as text or graphical user input objects, and/or configured to receive input or indications from a user and send a user-input signal indicative of the user input or indications to the processing circuitry 312. In embodiments, the processing circuitry 312 is communicatively coupled to the memory 315 and/or the communications interface 304 and/or the input device 317 and/or the display 318. The server 310 may be configured to send/receive data directly from another node or to send/receive data via the wired and/or wireless communications network 330.

In embodiments, the communications interface and/or transceiver 304 communicates using wired and/or wireless communication techniques.

In embodiments, the one or more memory 315 may comprise a selection of memories such as a hard RAM, disk drive, a floppy disk drive, a magnetic tape drive, an optical disk drive, a CD or DVD drive (R or RW), or other removable or fixed media drive.

In a further embodiment, the server 310 may further comprise and/or be coupled to one or more additional sensors (not shown) configured to receive and/or obtain and/or measure physical properties pertaining to the machine tool 110 and send one or more sensor signals indicative of the physical properties to the processing circuitry 312, e.g. sensor data indicative of a location of a cutting tool.

The controller 111 may comprise all or a subset of features of the server 310 described in relation to FIG. 3.

The computer or computer system 180 may comprise all or a subset of features of the server 310 described in relation to FIG. 3.

The cloud storage 320 may comprise all or a subset of features of the server 310 described in relation to FIG. 3.

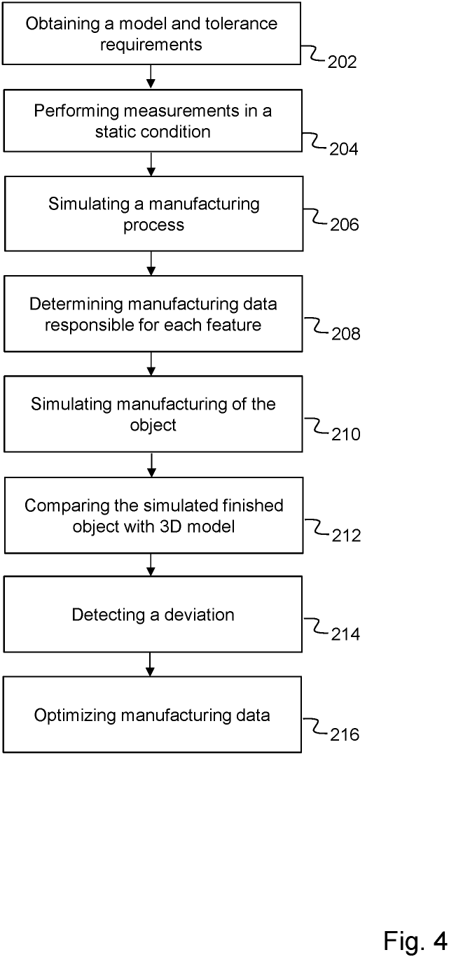

Looking now at FIG. 4, method steps according to a first embodiment of the present disclosure will be described.

The method comprises obtaining 202 a three-dimensional model, MODEL, of the object, OBJ, to be manufactured, wherein the three-dimensional model, MODEL comprises a reference geometry.

The model may be obtained by retrieving the three-dimensional model from memory. Additionally or alternatively, the three-dimensional model may be obtained by receiving a control signal comprising the three-dimensional model from other nodes, e.g. any one of the computer system 180, the server 310 or the cloud storage 320 or any other node.

The reference geometry may be indicative of dimensions and/or acceptable shape and tolerances of the object OBJ and/or individual features of the object OBJ. The reference geometry may comprise or be associated to related product and manufacturing information, PMI, and/or predetermined dimensioning and tolerancing data associated to the three-dimensional model suitable for performing geometric dimensioning and tolerancing analysis.

In one example, the computer system 180 retrieves the three-dimensional model MODEL from memory. In one further example, the computer system 180 receives the three-dimensional model MODEL comprised in a control signal from the server 310. The three-dimensional model MODEL may comprise or be associated to PMI and/or predetermined dimensioning and tolerancing data also optionally further comprised in the control signal.

The method further comprises performing measurements 204 on the manufacturing system in a static condition, in order to obtain static system information. The static system information denotes information regarding the system which is measurable when the system is static, meaning that there is no ongoing manufacturing process. The static system information comprises information regarding the positions and dimensions of components in the manufacturing system, as they are deployed at the premises in question. A reason the step of performing measurements 204 is that the information detailing the positions and dimensions of a manufacturing usually differs between theory and implementation. In many implementations today, the theoretical measurements are used, which is one of many causes for that manufactured objects deviate from expected outcomes.

The static system information may be obtained by any relevant measuring method, physical or digital, and as will be understood the methods for measuring different parts of the manufacturing may be different.

When the performing measurements step 204 has been completed, information regarding at least the positions and dimensions of components in the manufacturing system has been obtained, and further information may also have been obtained. In some embodiments, the performing measurements step 204 may comprise obtaining the positions and dimensions of all components in the system, and in some embodiments the positions and dimensions of some, but not all, components are obtained. The components referred to herein may be any component in the manufacturing system, such as machine tools, cutting tools, fixtures, and work pieces.

The method further comprises simulating 206 a manufacturing process in the subtractive manufacturing system using the obtained static information, in order to obtain runtime information. The simulating step 206 is performed due to that there is a lot of relevant information about a manufacturing system which is not possible to obtain when the system is standing still, such as how the different components affect and influence each other during a manufacturing process. Further, the reason for simulating step 206 is that actually running the system is relatively costly, and further that a manufacturing process aimed at determining runtime information would entail that the system cannot be used to actually manufacture an object during this time.

In some embodiments, the simulating step 206 comprises obtaining thermal expansion/contraction information, the thermal expansion/contraction information detailing the amount of thermo-mechanical deformation of components in the manufacturing system during a manufacturing process. In some embodiments, the thermal expansion/contraction information may further comprise details regarding how the these changes depending on environmental conditions such as surrounding temperature and humidity as well as the state of residual stresses.

In some embodiments, the simulating step 206 comprises obtaining information regarding the functional positions and measurements of components in the system, during a manufacturing process. The term functional positions and measurements is intended to denote the parts of a machine tool that are in engagement with the raw stock material during operation of a manufacturing process, i.e. the part(s) of the tool which touch(es) the raw stock during operation. An illustrative example is shown in FIG. 5, wherein a cutting insert 400 comprises a cutting edge 415, and a cutting edge portion 410. Depending on the manufacturing system, the object to be manufactured and the raw stock material, different parts of the cutting insert 400 may be in contact with the raw stock material during a manufacturing process. In an example where only the cutting edge 415 is in contact with the raw stock material, only the positions and measurements of the edge 415 need to be obtained according to embodiments in which the functional measurements and positions are obtained. In an example where the cutting edge portion 410 is in contact with the raw stock material, only the positions and measurements of the cutting edge portion 410 are obtained. Generally, the larger the part of the entire cutting insert 400 which is in engagement with the raw stock material, the more information needs to be gathered in order to obtain the functional measurements for such an insert 400 in such embodiments. Thus, the information describing the functional dimension and positions may be less than the information needed to describe the measurements and positions of the whole cutting insert 400, which is a reason for having embodiments wherein only the functional measurements and positions are obtained.

In some embodiments, the simulating step 206 comprises obtaining information regarding dynamic deviations of the manufacturing system. Dynamic deviations denotes deviations that occur due to differing movements of a tool as compared with an expected path the tool is supposed to take. Such differences may be due to a number of reasons. For example, the dynamic behavior of a tool may differ due to deflections and/or chatter vibration of the tools.

In some embodiments, the simulating step 206 comprises obtaining information regarding the wear of the tools overtime. Such information may further comprise details regarding how the wear changes depending on different conditions such as temperature of the tool, temperature of the surroundings, and humidity.

The simulations performed when performing the simulating step 206 may comprise performing a large number of simulations and varying relevant variables in the manufacturing system for each simulation. The actual behavior of a manufacturing system is generally better simulated with such non-deterministic processes than deterministic processes, and most currently available systems today uses deterministic processes. In some embodiments, the step of obtaining 206 further comprises obtaining information regarding the interdependence of different components and how changes in one component may affect others.

In some embodiments the simulating step 206 comprises varying the static system information, based on the obtained static system information, such that values obtained from the measuring step 204 are used as a baseline for the varying.

In some embodiments, all of the dimensions and positions obtained from the measuring step 204 are varied. In some embodiments, selected ones of the obtained positions and measurements are varied. In some embodiments, only the positions and dimensions corresponding to a specific tool are varied. An illustrative example will now be described regarding how the static system information may be varied during the non-deterministic simulation of a manufacturing process of the object to be manufactured.

For a specific position or measurement that is to be varied, the corresponding value obtained in step 204 is used as the baseline, i.e. the starting value, which may be selected as e.g. the middle point of a normal distribution. The values are the varied according to a predetermined and/or assumed normal distribution, such as is done in e.g. Monte Carlo analyses. The normal distribution may in some embodiments be based on the capabilities of the system, such that the furthest position a tool can reach on one side is used as one end point for the normal distribution, and the further position the same tool can reach on the other side is used as the other end point for the normal distribution. In some embodiments, the normal distribution may be based on predetermined variations, such as e.g. +-1% +-5%, +-10%, +- 20%, +-50%, or any other suitable number, from the position or measurement measured in step 204.

In embodiments wherein selected ones of the obtained positions and measurements are varied, the method may further comprise a step of, prior to the simulating step 206, determining the tools which are most critical for the functioning of a finished product manufactured using the system. The varying may then be performed for the measurements and dimensions of the tools which have been determined as the most critical ones.

In some embodiments, the simulating step 206 comprises performing a first simulation of the manufacturing process in order to obtain values for the runtime system information. The method may then further comprise also varying the runtime system information in the same manner as the static information is varied, as described above, with the values obtained from the first simulation as a baseline. In some embodiments, the simulating step 206 may be performed using another object to be manufactured than the object that is about to be manufactured, in other words the system may be calibrated using another object than the one about to be produced. In some embodiments, this may be an object suitable for detecting as many possible sources of errors as possible.

In some embodiments, the method may further comprise a step of optimizing tolerance requirement data, based on the obtained static information and on the obtained runtime information. In some embodiments, optimizing the tolerance requirement data comprises performing a tolerance chain analysis, which determines the tolerance requirements for the manufactured object as a whole, in addition to the tolerance requirements for each feature, as is normally the case. In some embodiments, performing a tolerance chain analysis comprises summing up the tolerance requirements for all parts involved. For example, for a simple object comprising three features on top of each other, a tolerance chain analysis would add the tolerance requirement for each part together, to obtain the tolerance requirement of the object as a whole. If the first feature had a height tolerance requirement of +-0,3 mm, the second feature a tolerance of -0,5 to 0,1 mm, and the third feature -0,2 to 0,7 mm, the height tolerance requirement of the object as a whole would be -1 to +1, 1 mm. As will be understood, the same operations may be performed for the width and depth as well, and it is also possible to express the same information in other ways.

After the simulating step 206, the method further comprises determining 208 which manufacturing data is responsible for producing each feature of the object in a manufactured object. Manufacturing data denotes any information needed as input in the system in order to manufacture an object, including at least cutting data, tool location data and tool path data. Cutting data is data which controls parameters of the manufacturing system, including at least feed rate, cutting speed and depth of cut.

Tool path data is data describing the path that a tool, or a plurality of tools, travels along during a manufacturing process of the object to be manufactured. In some embodiments, the entire manufacturing process is considered to be one and the same tool path. In some embodiments, all movement performed by one particular machine is considered as the tool path for that machine, and all machine tool paths make up the system tool path. In some embodiments, all movement performed by a particular tool is consider as the tool path for that tool, and all such tool paths make up the system tool path.

The determining step 208 comprises using the information gained from simulation of a manufacturing of the object to be manufactured, to map a relationship between manufacturing data and each feature of an object. The determining step 208 comprises determining the manufacturing data responsible for each feature of a product, such that the manufacturing data controlling the operation of the machining system for any particular feature can be determined.

In some embodiments, the determining step 208 comprises determining which part of the manufacturing process is responsible for a final resulting feature of a product. In order to make such a determination, it needs to be understood which part of the manufacturing process performs the final tasks for a specific feature as it is in the finished object. The reason for only needing to consider the final tasks, is that the work before that may not always be relevant for the finished product.

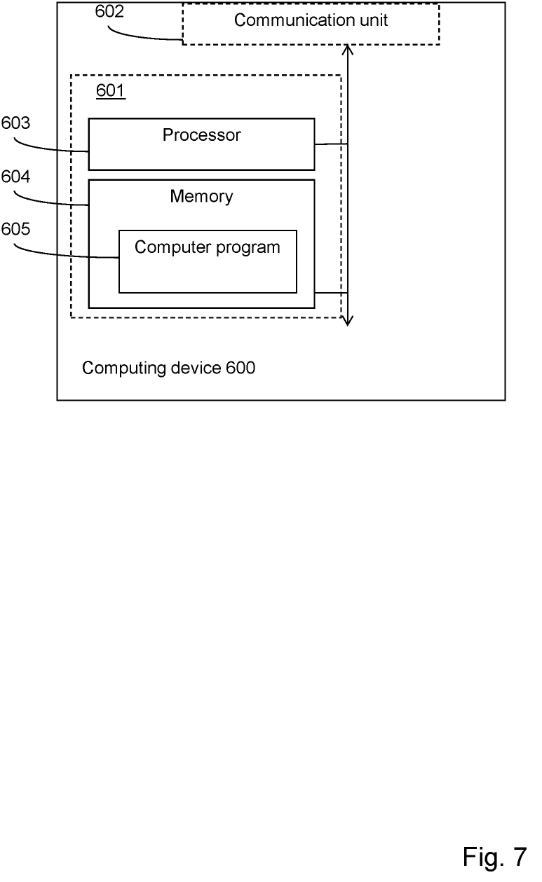

Consider a simple case with the raw stock material being a cube 500, and the finished product or final resulting feature 510 is the lower half of the cube 500, and further that the top half of the cube 500 will be removed by a plurality of subsequent milling operations, as is illustrated in FIG. 6. In FIG. 6, there are four top layers 501, 502, 503, 504 that need to be removed before the final layer 505 is removed. The removal of the four top layers 501, 502, 503, 504 will in such a case not be relevant for the finished product or feature 510, but the removal of the final layer 505 will be. In this example, the removal of layers 501, 502, 503, 504, while highly relevant for achieving the final product, are not relevant for the actual functions and measurements of the final product or feature 510. The above is intended to illustrate the meaning of considering the machining operation responsible for a final resulting feature 510 in question, i.e. the part of the operation which is relevant for and which affects a resulting feature’s function. In some embodiments, the method comprises determining 208 manufacturing data responsible for each resulting feature, and determining manufacturing data responsible for removal operations which do not affect the functioning of the final product or feature 510, which in the example illustrated in FIG. 5 would be the manufacturing data responsible for the removal of layers 501, 502, 503 and 504.

In some embodiments, determining which part of the manufacturing process is responsible for a resulting feature of a product comprises determining which tool(s) is/are physically touching the finished feature 510.

The method further comprises simulating 210 manufacture of the object to be manufactured, using the obtained static information and the obtained runtime information. A difference between the first simulating step 206 and the second simulating step 210, is that the information obtained from the first simulating step 206 is used as input for the second simulating step 210, which entails that the second simulation 210 provides a more accurate representation of an actual manufacturing process for manufacturing the object the be manufactured.

The method further comprises comparing 212 the finished product as simulated in step 210, with a model illustrating an ideal finished product. In some embodiments, the ideal finished product is illustrated by the same model as is obtained in the first step 200. In some embodiments, the model illustrating the ideal finished product may differ from the model provided in step 200, due to various factors such as the model obtained in 200 comprising more information, which may be e.g. tolerance requirement information and/or other PMI.

The method further comprises optimizing 214 the manufacturing data, based on the detected deviation, such that an object manufactured using the optimized manufacturing data is more similar to the model of the ideal finished product than an object manufactured using non-optimized manufacturing data. A reason for having such an optimizing step 214, is the insight that certain parameters of a manufacturing system, such as the manufacturing data in form of cutting data and tool path data, are easier and more suitable to change than others. The positions of the tools and machines in a system takes relatively long to change, requires physical labor, and will likely create as many errors as they remove. By instead only optimizing the input data to the manufacturing system, an efficient process may be achieved which is much less costly, and also provides more accurate results in terms of objects meeting the tolerance requirements.

FIG. 7 shows a computing device 600, operable for optimizing manufacturing data. The computing device 600 comprises processing circuitry 603 and a memory 604. The processing circuitry 603 may comprise one or more programmable processor, application-specific integrated circuits, field programmable gate arrays or combinations of these (not shown) adapted to execute instructions. The memory contains instructions executable by said processing circuitry, whereby the computing device 600 is operative for obtaining a model of and tolerance requirements for the object to be manufactured, and performing measurements on the manufacturing system in a static condition, in order to obtain static system information, the static system information describing the positions and dimensions of components in the manufacturing system. The computing device 600 is further operative for simulating a manufacturing process in the subtractive manufacturing system using the obtained static information, in order to obtain runtime information, the runtime information describing the behavior of the manufacturing system during a manufacturing process and determining which manufacturing data is responsible for producing each feature of the object in a manufactured object. The computing device 600 is further operative for simulating manufacturing of the object, using the obtained static information and the obtained runtime information, comparing the simulated finished product of the object with the three-dimensional model of the object, detecting a deviation between the simulated finished product and the obtained tolerance requirements comprised in the model of the object, and based on the detected deviation and the determination of which manufacturing data is responsible for producing each feature, optimizing the manufacturing data such that an object manufactured based on the optimized manufacturing data complies with the obtained tolerance requirements.

The computing device 600 that performs the method may be a group of devices, wherein functionality for performing the method are spread out over different physical, or virtual, devices of the system. In other words, the computing device 600 for optimizing manufacturing data may be a cloud-solution, i.e. the computing device 600 may be deployed as cloud computing resources that may be distributed in the system. In some embodiments, the computing device 600 is the computer system 180 of FIG. 2.

According to an embodiment, the computing device 600 is further operative for updating the static information based on the obtained runtime information.

According to an embodiment the computing device 600 is further operative for optimizing the tolerance requirement data.

According to an embodiment the computing device 600 is further operative for obtaining thermal expansion and/or contraction information.

According to an embodiment the computing device 600 is further operative for obtaining functional positions and measurements of each component in the system.

According to an embodiment the computing device 600 is further operative for obtaining tool wear information.

According to an embodiment the computing device 600 is further operative for performing a tolerance chain analysis.

According to an embodiment the computing device 600 is further operative for determining the machining operation responsible for a final resulting feature.

According to an embodiment the computing device 600 is further operative for

According to an embodiment the computing device 600 is further operative for obtaining information regarding dynamic deviations.

According to an embodiment the computing device 600 is further operative for performing a large number of simulations and varying relevant variables in the manufacturing system for each simulation.

According to other embodiments, the computing device 600 may further comprise a communication unit 602, which may be considered to comprise conventional means for communicating with other components in the manufacturing system. The instructions executable by said processing circuitry 603 may be arranged as a computer program 605 stored e.g. in the memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above.

The computer program 605 may comprise computer readable code means, which when run in a computing device 600 causes the computing device 600 to perform the steps described in any of the described embodiments of the computing device 600. The computer program 605 may be carried by a computer program product connectable to the processing circuitry 603. The computer program product may be the memory 604. The memory 604 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 604. Alternatively, the computer program may be stored on a server or any other entity connected to the subtractive manufacturing system, to which the computing device 600 has access via the communication unit 602. The computer program may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method for optimizing manufacturing data in a subtractive manufacturing system, the manufacturing system being arranged to manufacture an object based on a three-dimensional model, the object having a plurality of features, the method comprising:
obtaining a model of and tolerance requirements for the object to be manufactured;
performing measurements on the manufacturing system in a static condition in order to obtain static system information, the static system information describing positions and dimensions of components in the manufacturing system;
simulating a manufacturing process in the subtractive manufacturing system using the obtained static information, in order to obtain runtime information, the runtime information describing behavior of the manufacturing system during a manufacturing process;
determining which manufacturing data is responsible for producing each feature of the object in a manufactured object;
simulating manufacturing of the object using the obtained static information and the obtained runtime information;
comparing the simulated finished product of the object with the three-dimensional model of the object;
detecting a deviation between the simulated finished product and the obtained tolerance requirements comprised in the model of the object; and
based on the detected deviation and the determination of which manufacturing data is responsible for producing each feature, optimizing the manufacturing data such that an object manufactured based on the optimized manufacturing data complies with the obtained tolerance requirements.

2. The method according to claim 1, further comprising updating the static information based on the obtained runtime information.

3. The method according to claim 1, further comprising optimizing the tolerance requirement data.

4. The method according to claim 3, wherein optimizing the tolerance requirement data includes performing a tolerance chain analysis.

5. The method according to claim 1, wherein the simulating a manufacturing process includes obtaining thermal expansion and/or contraction information.

6. The method according to claim 1, wherein the simulating a manufacturing process includes obtaining functional positions and measurements of components in the system.

7. The method according to claim 1, wherein the simulating a manufacturing process includes obtaining tool wear information.

8. The method according to claim 1, wherein the simulating a manufacturing process includes obtaining information regarding dynamic deviations.

9. The method according to claim 1, wherein the simulating a manufacturing process includes performing a large number of simulations and varying relevant variables in the manufacturing system for each simulation.

10. The method according to claim 1, wherein determining which manufacturing data is responsible for producing each feature of the object in a manufactured object includes determining the machining operation responsible for a final resulting feature.

11. A computing device operable for optimizing manufacturing data in a subtractive manufacturing system, the manufacturing system being arranged to manufacture an object based on a three-dimensional model, the object having a plurality of features, the computing device comprising:
processing circuitry ; and
a memory , said memory containing instructions executable by said processing circuitry , whereby said computing device is operative for:
obtaining a model of and tolerance requirements for the object to be manufactured;
performing measurements on the manufacturing system in a static condition, in order to obtain static system information, the static system information describing positions and dimensions of components in the manufacturing system;
simulating a manufacturing process in the subtractive manufacturing system using the obtained static information, in order to obtain runtime information, the runtime information describing behavior of the manufacturing system during a manufacturing process;
determining which manufacturing data is responsible for producing each feature of the object in a manufactured object;
simulating manufacturing of the object using the obtained static information and the obtained runtime information;
comparing the simulated finished product of the object with the three-dimensional model of the object;
detecting a deviation between the simulated finished product and the obtained tolerance requirements comprised in the model of the object; and
based on the detected deviation and the determination of which manufacturing data is responsible for producing each feature, optimizing the manufacturing data such that an object manufactured based on the optimized manufacturing data complies with the obtained tolerance requirements.

12. The computing device according to claim 11, further operative for performing the steps of a method according to claim 1.

13. A system for optimizing manufacturing data, arranged to manufacture an object based on a three-dimensional model, the object having a plurality of features, the system comprising:
a computing device according to claim 12; and
at least one machine tool configured to machine the object based on instructions obtained from the computing device.

14. A computer program including computer readable code means to be run in the computing device, which computer readable code means when run in the computing device causes the computing device to perform the following steps:
obtaining a model of and tolerance requirements for the object to be manufactured;
performing measurements on the manufacturing system in a static condition in order to obtain static system information, the static system information describing the positions and dimensions of components in the manufacturing system;
simulating a manufacturing process in the subtractive manufacturing system using the obtained static information in order to obtain runtime information, the runtime information describing the behavior of the manufacturing system during a manufacturing process;
determining which manufacturing data is responsible for producing each feature of the object in a manufactured object;
simulating manufacturing of the object using the obtained static information and the obtained runtime information;
comparing the simulated finished product of the object with the three-dimensional model of the object;
detecting a deviation between the simulated finished product and the obtained tolerance requirements comprised in the model of the object; and
based on the detected deviation and the determination of which manufacturing data is responsible for producing each feature, optimizing the manufacturing data such that an object manufactured based on the optimized manufacturing data complies with the obtained tolerance requirements.

15. A carrier containing the computer program according to claim 14, wherein the carrier is one of an electronic signal, optical signal, radio signal or computer readable storage medium.
